(19) United States
(12) Patent Application Publication
(10) Pub. No.: US 2003/0163929 A1
(43) Pub. Date: Sep. 4, 2003

(54) Compressor unit, provided with an adsorption dryer and adsorption dryer therefor

(76) Inventor: Danny Etienne Andree Vertriest, Kontich (BE)

Correspondence Address: BACON & THOMAS, PLLC, 625 SLATERS LANE, FOURTH FLOOR, ALEXANDRIA, VA, 22314

(21) Appl. No.: 10/275,279

(22) PCT Filed: May 15, 2001
(86) PCT No.: PCT/BE01/00085

(30) Foreign Application Priority Data
May 17, 2000 (BE) 2000331

(51) Int. Cl. F26B 21/06

(52) U.S. Cl. 34/80

(57) ABSTRACT

The invention relates to a compressor unit comprising a compressor unit comprising compressor element (2), the outlet conduit (3) of which connects to an adsorption dryer (6) with a vessel (8) and a rotor (7) mounted therein. On each of the extremities of the vessel (8), two compartments (20, 21, 23, 24) are formed. The portion of the rotor (7) situated between one compartment (24) n he o extremity and a compartment (21) on the other extremity forms a drying chamber (9), whereas the portion of the rotor (7.) situated between the other compartments (20, 24) forms a regeneration chamber (10) and is situated in the outlet conduit (3) upstream of a cooler (4). Between the compartments (20, 21, 213, 24) on each extremity, a separation compartment (22, 25) is formed and means (30, 21) are provided to remove gas therefrom (22, 25).

This invention relates to a compressor unit comprising at least one compressor element, the outlet of which, by means of an outlet conduit, through a cooler and a water separator, connects to an adsorption dryer of the type comprising a vessel, a rotor mounted therein in a rotatable manner, and means for rotating the rotor, whereby on each of the extremities of the vessel, in front of an extremity of the rotor, at least two separated compartments are formed, respectively provided with an inlet or outlet for the supply, discharge, respectively, of gas and whereby the portion of the rotor situated between a compartment on the one extremity and a compartment on the other extremity of the vessel forms a drying chamber which is filled with a regeneratable drying agent and the portion of the rotor situated between the other compartment on the first-mentioned extremity and the other compartment on the other extremity of the vessel forms a regeneration chamber which is filled with regeneratable drying agent.

Such compressor units provided with an adsorption dryer are described, for example, in the patent documents U.S. Pat. No. 5,385,603 and GB-A-1.349.733.

The compressor comprises a compressor element which, by means of a main conduit, through a cooler and a separator of the condensed water, is connected to the compartment at the inlet of the drying chamber, whereas a branch of the main conduit situated upstream of the cooler connects to the compartment at the inlet of the regeneration chamber and a return conduit connects the compartment at the outlet of the regeneration chamber to the main conduit at the height of an ejector.

During the drying of gas in the drying chamber, the drying agent, which, in a previous cycle, has been saturated with moisture, is regenerated in the regeneration chamber by directing a portion, for example, 40%, of the compressed air of the compressor element therethrough and, after cooling down and separating the condensed water, by feeding it, through the return conduit and the ejector, back to the gas which still has to be dried.

Due to the necessity of a secondary conduit, a return conduit and a mixer, such as the ejector, for mixing moisture-laden gas from the regeneration chamber again with compressed air from the compressor element, these known compressor units are provided with an adsorption dryer which has a rather complicated construction and is expensive.

Moreover, in critical circumstances, the regeneration is insufficient, to wit when the load on the compressor element is low and the temperature for the regeneration is not sufficiently high.

The invention has as an aim to remedy these disadvantages and to provide a compressor unit, provided with an adsorption dryer, which has a more simple construction and whereby also with a low load on the compressor element an efficient regeneration of the drying agent is possible.

According to the invention, this aim is realized in that the portion of the rotor which forms the regeneration chamber is situated in the outlet conduit between the compressor element and the cooler and that between said compartments on the one extremity of the vessel and between said compartments on the other extremity, a separation compartment is formed which separates the compartments from each other and that means are provided for removing gas from these separation compartments until the pressure in these separation compartments is lower than the pressure in the compartment which is situated at an extremity of the drying chamber and which is provided with the outlet for gas.

Due to pressure losses in the unit, the pressure in this compartment is somewhat lower than the outlet pressure of the compressor element.

Thus, the entire flow rate of compressed gas flows through the regeneration chamber and is cooled by the cooler pertaining to the compressor unit and is freed of condensation by the water separator before being dried, which is possible due to the special construction of the adsorption dryer. No additional cooler is necessary for removing the moisture from the gas used for regeneration.

It is known, amongst others, from U.S. Pat. No. 3,205,638 and FR-A-2.380.063, to direct the entire flow rate of compressed gas through the regeneration chamber of an adsorption dryer, but the adsorption dryer is of another type, to wit, without a rotor, but with fixed, completely separated chambers which, by means of selector valves, connect to the outlet conduit and whereby the alternation of drying and regenerating is obtained by altering the state of these selector valves.

With the known adsorption dryers having a rotor, this was not possible, in consideration of the fact that there are always leaks between the rotor and the compartments at the extremity of the vessel. As a result thereof, at one extremity of the vessel hot gas at high pressure, originating from the compressor element, will leak towards the compartment being at a lower pressure which connects to the drying chamber, whereas at the other extremity of the vessel, the still warm and moisture-laden gas leaving the regeneration chamber will leak towards the compartment which connects to the outlet of the drying chamber, and the cold, dried gas will warm up and become humid again.

These problems are solved by the invention.

The two compartments at the extremities can be in mutual connection, for example, by at least one portion of the rotor which is situated between the portions forming the drying chamber and the regeneration chamber.

Said means can comprise an ejector in the outlet conduit which, by means of a suction conduit, is in connection with a compartment.

The invention also relates to an adsorption dryer of the type comprising a vessel, a rotor mounted therein in a rotatable manner, and means for rotating the rotor, whereby on each of the extremities of the vessel, in front of an extremity of the rotor, at least two separated compartments are formed, respectively provided with an inlet or outlet for the supply, discharge, respectively, of gas, and the portion of the rotor, situated between a compartment on the one extremity and a compartment on the other extremity of the vessel, forms a drying chamber which is filled with a regeneratable drying agent, and the portion of the rotor, situated between the other compartment on the first-mentioned extremity and the other compartment on the other extremity of the vessel, forms a regeneration chamber which is filled with regeneratable drying agent, and which is characterized in that the portion of the rotor which forms the regeneration chamber is situated in the outlet conduit between the compressor element and the cooler and that, between said compartments on the one extremity of the vessel and between said compartments on the other extremity of the vessel, a separation compartment is formed which separates the compartments from each other and that means are provided for removing gas from these separation compartments.

With the intention of better showing the characteristics of the invention, hereafter, as an example without any limitative character, a preferred form of embodiment of an adsorption dryer and of a compressor unit provided with such adsorption dryer according to the invention is described, with reference to the accompanying drawings, wherein:

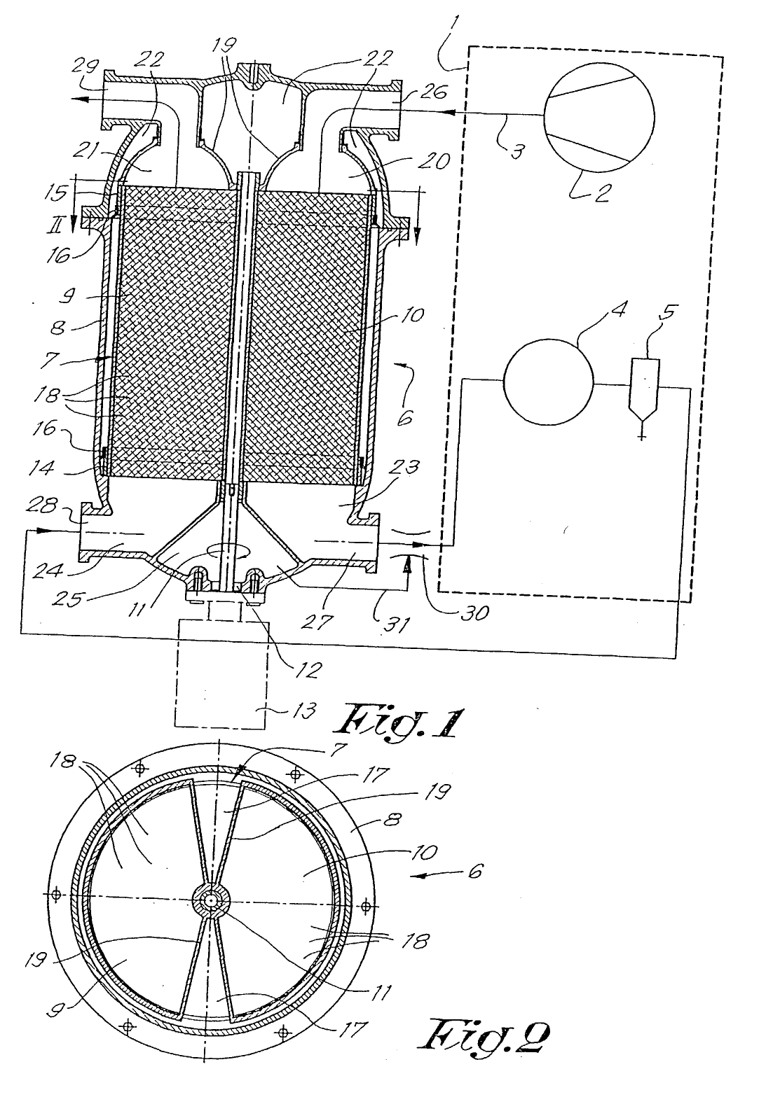

FIG. 1 schematically represents a compressor unit provided with an adsorption dryer according to the invention;

FIG. 2 represents a cross-section according to line II-II in FIG. 1.

The compressor unit schematically represented in FIG. 1 consists of, on one hand, a compressor 1 which substantially comprises a compressor element 2, and in the outlet conduit 3 thereof a cooler 4, followed by a water separator 5, and, on the other hand, an adsorption dryer 6 of the type with a rotor 7 which is mounted in an upright vessel 8 in a continuously rotatable manner and in which a drying chamber 9 and a regeneration chamber 10 are formed.

The rotor 7 is fixed to a vertical shaft 11 which is beared in a bearing 12 in the lowermost extremity of the vessel 8 and, usually, will be driven continuously by a motor 13 forming driving means for the rotor 7.

The rotor 7 consists of a bundle of vertical tubes.

On the extremities of the rotor 7, these tubes are held together by a ring 14 or 15.

By means of the lowermost ring 14, the rotor 7 rests upon an edge of the vessel 8. On the lowermost ring 14 as well as on the uppermost ring 15, a rubber sealing 16 is fixed which drags against the vessel wall.

The drying chamber 9 and the regeneration chamber 10 are formed by parts of the rotor 7 which are each other's mirror image and which together surround the shaft 11.

Said tubes forming the drying chamber 9 as well as the regeneration chamber 10 are filled with a regeneratable drying agent 18, such as silica gel.

The extremities of the vessel 8, situated in front of the extremities of the rotor 7, are separated into compartments by partitions 19, to wit two compartments 20 and 21 at the top with therein between a separation compartment 22 and two compartments 23 and 24 at the bottom with therein between a separation compartment 25.

The drying chamber 9 is the part of the rotor 7 which is situated between compartments 21 and 24, whereas the regeneration chamber 10 is the part of the rotor 7 which extends between compartments 20 and 23.

Due to the presence of the separation compartments 21 and 25, the drying chamber 9 and the regeneration chamber 10 have a horizontal cross-section which is smaller than half a circle and, for example, covers a circle segment of approximately 160°.

The separation compartments 21 and 25 are in connection with each other by means of portions 17 of the rotor 7 which are situated between the formed drying chamber 9 and regeneration chamber 10.

The compartment 20 connects to the uppermost extremity or the inlet of the regeneration chamber 10 and is provided with an inlet 26 which, by outlet conduit 3, is in direct connection with the outlet of the compressor element 2, whereas the compartment 23 connects to the lowermost extremity of this regeneration chamber 10 and is provided with an outlet 27 which, by outlet conduit 3, is connected to the inlet of cooler 4.

In an analogous manner, the lowermost compartment 24 connects to the lowermost extremity or the inlet of the drying chamber 9 and is it provided with an inlet 28 which, by outlet conduit 3, connects to the outlet of the water separator 5, whereas the uppermost compartment 21 connects to the uppermost extremity or the outlet of the drying chamber 9 and is provided with an outlet 29.

Means are provided for removing gas from these separation compartments 22 and 25 and, thus, also from the portions 17 of the rotor 7 and for reducing the pressure therein until it drops below the pressure of the dried gas in compartment 21.

In the represented example, these means are formed by an ejector 30 which is positioned between the outlet 27 and the cooler 4 in the outlet conduit 3, and the suction conduit 31 of which, which conduit gives out into its narrowed part, connects to compartment 25.

In a variant., these means can be formed by a suction pump or a fan which suck off gas from one of the compartments 22 and 25 or the portions 17 of the rotor 7.

The functioning of the compressor unit described in the aforegoing is as follows:

The entire flow rate of warm, compressed gas supplied by compressor element 2 flows, through outlet conduit 3, inlet 26 and compartment 20 into the regeneration chamber 10, where, anyhow, if the compressor unit already has been operating for a time, moist drying agent 18 is situated.

In the regeneration chamber 10, this warm gas takes up the moisture as a result of which this drying agent 18 is regenerated. The humid warm gas flows through compartment 23, outlet 27 and, therefore, through ejector 30, towards the cooler 4 where, as a result of cooling, the moisture is condensed.

Due to this flow, a negative pressure will be created in the ejector 30, such that, by means of suction conduit 31, gas is sucked from the separation compartment 25 and, by means of the portions 17 of the rotor 7, also from the separation compartment 22 at the top.

As a consequence, warm gas under pressure, which inevitably leaks between compartments 20 and 23, on one hand, and the rotor 7, on the other hand, will not reach compartments 21 and 24 and therefore will not be mixed with the cooled and, by means of the water separator, desiccated gas.

In the water separator 5, the condensed water and the cold, desiccated gas are brought through inlet 28 and compartment 24 into the drying chamber 9, where it is dried further, after which, through compartment 21 and outlet 29, it leaves the adsorption dryer 6 cold and in dry condition in order to be used.

Cold gas which possibly may leak from compartments 21 and 24 will end up in the separation compartment 22, 25, respectively, and therefore will be sucked off through separation compartment 25 by means of the ejector 30, such that no leaking cold gas reaches the compartments 20 and 23 and can not cool down the warm gas in this latter.

The continuous rotational speed of the rotor 7 is chosen such that, when the drying agent 18 in a tube is saturated with moisture, this tube stops with forming part of the drying chamber 9. After a small further rotation of the rotor 7, the same tube will form a part of the regeneration chamber 10 and at the time that this tube stops forming a part of this regeneration chamber 10, the drying agent 18 in this tube is regenerated, such that this drying agent can be re-used for drying as soon as the tube again forms a part of the drying chamber 9.

Before cooling moisture-laden gas from the regeneration chamber 10, the cooler is used by the compressor 1, such that the compressor unit comprises only one cooler and is of a simple construction.

Also with a low load, the gas is dried in an optimum manner.

In the adsorption dryer, more than one drying chamber 9 and/or regeneration chamber 10 can be formed, whereby the different drying chambers 9, regeneration chambers 10, respectively, give out at an extremity of the vessel 8 to separate compartments or to one common compartment.

The compressor may be a multi-stage compressor and, thus, comprise two or even more compressor elements which are positioned one after the other. In this case, the compressor element which is connected to the adsorption dryer 6, of course is the last or high-pressure compressor element.

The invention is in no way limited to the forms of embodiment described in the aforegoing, on the contrary, such compressor unit and adsorption dryer therefor may be realized in different variants without leaving the scope of the invention.

1.- Compressor unit comprising at least one compressor element (2), the outlet of which, by means of an outlet conduit (3), connects, over a cooler (4) and a water separator (5), to an adsorption dryer (6) of the type comprising a vessel (8), a rotor (7) mounted therein in a rotatable manner, and means (13) for rotating the rotor (7), whereby on each of the extremities of the vessel (8), in front of an extremity of the rotor (7), at least two separated compartments (20,21;23,24) are formed, respectively provided with an inlet or outlet (28,26;29,27) for the supply, discharge, respectively, of gas, and the portion of the rotor (7) situated between a compartment (24) on the one extremity and a compartment (21) on the other extremity of the vessel (8) forms a drying chamber (9) which is filled with a regeneratable drying agent (18), and the portion of the rotor (7) situated between the other compartment (20) on the first-mentioned extremity and the other compartment (24) on the other extremity of the vessel forms a regeneration chamber (10) which is filled with regeneratable drying agent (18), characterized in that the portion of the rotor (7) which forms the regeneration chamber (10) is situated in the outlet conduit (3) between the compressor element (2) and the cooler (4) and that, between said compartments (20,21) on the one extremity of the vessel (8) and between said compartments (23,24) on the other extremity of the vessel (8), a separation compartment (22,25) is formed which separates the compartments (20 and 21; 23 and 24) from each other and that means (30,21) are provided for removing gas from these separation compartments (22,25) until the pressure in these separation compartments (22,25) is lower than the pressure in the compartment (21) which is situated at one extremity of the drying chamber (9) and which is provided with the outlet (29) for gas.

2.- Compressor unit according to claim 1, characterized in that the separation compartments (22,25) at both extremities are in mutual connection.

3.- Compressor unit according to claim 2, characterized in that the separation compartments (22,25) on both extremities are in mutual connection by means of at least one portion (17) of the rotor which is situated between the portions forming the drying chamber (9) and the regeneration chamber (10).

4.- Compressor unit according to any of the claims 1 to 3, characterized in that the means for removing gas from the separation compartments comprise an ejector (30) in the outlet conduit (3) which, by a suction conduit (31), is in connection with a compartment (25).

5.- Compressor unit according to claim 4, characterized in that the ejector (30) is situated between the adsorption dryer (6) and the cooler (4).

6.- Adsorption dryer (6) of the type comprising a vessel (8), a rotor (7) mounted therein in a rotatable manner, and means (13) for rotating the rotor (7), whereby at each of the extremities of the vessel (8), in front of an extremity of the rotor (7), at least two separated compartments (24,21;20,23) are formed, respectively provided with an inlet or outlet (28,26;29,27) for the supply, discharge, respectively, of gas, and the portion of the rotor (7), situated between a compartment (24) on the one extremity and a compartment (21) on the other extremity of the vessel (8), forms a drying chamber (9) which is filled with a regeneratable drying agent (18), and the portion of the rotor (7), situated between the other compartment (20) on the first-mentioned extremity and the other compartment (24) on the other extremity of the vessel, forms a regeneration chamber (10) which is filled with regeneratable drying agent (18), and which is characterized in that the portion of the rotor (7) which forms the regeneration chamber (10) is situated in the outlet conduit (3) between the compressor element (2) and the cooler (4) and that, between said compartments (20,21) on the one extremity of the vessel (8) and between said compartments (23,24) on the other extremity of the vessel (8), a separation compartment (22,25) is formed which separates the compartments (20 and 21; 23 and 24) from each other and that means (30,21) are provided for removing gas from these separation compartments (22,25).

7.- Adsorption dryer (6) according to claim 6, characterized in that the separation compartments (22,25) on both extremities are in mutual connection.

8.- Adsorption dryer (6) according to claim 7, characterized in that the separation compartments (22,25) are in mutual connection by means of at least one portion (17) of the rotor (7) which is situated in, between the portions forming the drying chamber (9) and the regeneration chamber (10).

9.- Adsorption dryer (6) according to any of the claims 6 to 8, characterized in that it comprises only one drying chamber (9) and one regeneration chamber (10).

10.- Adsorption dryer (6) according to claims 8and 9, characterized in that the drying chamber (9) and the regeneration chamber (10) have a cross-section perpendicular to their longitudinal direction having the shape of a circle sector of approximately 160°.

11.- Adsorption dryer (6) according to any of the claims 6 to 10, characterized in that the means for removing gas from the separation compartments comprise a suction conduit (31) which is connected to an ejector (30).
